(19) United States
(12) Patent Application Publication
(10) Pub. No.: US 2010/0303398 A1
(43) Pub. Date: Dec. 2, 2010

(54) BEARING UNIT

(75) Inventors: Andre Anger, Uehlfeld (DE); Klaus Scharinger, Gauchsdorf (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/680,356

(22) PCT Filed: Aug. 11, 2008
(86) PCT No.: PCT/EP08/60540

§ 371 Date: May 3, 2010

(30) Foreign Application Priority Data
Sep. 28, 2007 (DE) 10 2007 046 527.2

(51) Int. Cl. F16C 19/46

(52) U.S. Cl. 384/572

(57) ABSTRACT

A bearing unit which has a bearing shell with a projection which plastically deforms a bore of an adjacent component, on assembly, to produce a recess, thereby securing the bearing shell against being axially displaced in the direction of a bearing axis and from being twisted in the peripheral direction. The position and anti-twist locking effect is thus achieved by producing a recess in the adjacent component in which recess the projection is accommodated in a positive fit. The bearing unit is preferably used for bearing a starter shaft in a starter of a motor vehicle.

### FIELD OF THE INVENTION

The present invention relates to a bearing unit, in particular for a starter of a motor vehicle, a throttle valve, a diesel assembly or a radial piston pump.

### BACKGROUND OF THE INVENTION

In the case of bearing units, it must be ensured that the position of a bearing shell with respect to an adjacent or adjoining component (referred to hereinafter as “adjacent component”) is maintained, even during operation of the bearing unit and when thermal expansions occur for operationally induced temperature changes, in which case axial migration of the bearing shell and/or rotation of the bearing shell with respect to the adjacent component should be avoided, for example. For this purpose, it is known from the prior art to support the bearing shell with a press fit with a very large oversize with respect to the adjacent component. Alternatively or in addition, it is possible to provide securing using a mechanical element, for example a securing ring or a nut, or by means of an adhesive bond between the bearing shell and adjacent component, a design of the bearing shell with a flange-like collar which comes to bear against the adjacent component for axial securing, or by calking the adjacent component to the bearing shell and the like.

DE-OS 1 525 296 discloses the mounting of a shaft of a steering mechanism via a needle bearing with respect to a housing wall. The needle bearing has a bearing sleeve which is produced from sheet metal and on which the needles roll radially on the outside. The bearing sleeve has a circumferential bead or U-shaped folding which is formed integrally by the sheet metal, protrudes radially outward and forms a flange-like abutment. In the installed state, the flange-like abutment comes to bear against the housing wall, as a result of which the bearing sleeve and therefore the needle bearing are axially secured on one side in a positively locking manner with respect to the housing wall. Additional axial securing in the other direction can be achieved using an end plate having an annular recess which can accommodate the flange-like abutment. The end plate is connected to that outer side of the housing wall which is associated with the flange-like abutment, the flange-like abutment being “trapped” between the housing wall and the end plate.

DE 39 31 447 A1 discloses the arrangement of a rolling bearing, which is in the form of a cylindrical roller bearing, with a press fit on a softer bearing seat surface of a machine part and of a bearing housing. A bearing shell of the rolling bearing is positionally secured in a positively locking manner by at least one circumferential groove in the contact region between the rolling bearing ring and the machine part and housing. The groove has a sharp-edged transition to the cylindrical lateral surface of the bearing shell. The press fit which is chosen between the bearing shell and the machine part and housing means that material of the machine part and of the housing oozes into the groove during mounting and swells the machine part or the housing, which should produce a positive lock which brings about axial positional securing. The sharp edges of the grooves can “shave” material off the softer surface of the bearing seat. The material can accumulate in the grooves. Alternatively, the surface of the bearing seat may become damaged by the sharp edges of the grooves, with a simultaneous wear effect, as a result of the pushing-on movement along the bearing seat.

DE 29 05 683 A1 discloses the mounting of an axle shaft of a rear-wheel transmission via two rolling bearings which are in the form of tapered roller bearings. The tapered roller bearings are supported on the housing with the interposition of two sleeves which are L-shaped in half longitudinal section, wherein a longitudinally oriented limb of the L provides an inner lateral surface for supporting radial forces of the rolling bearings, while a radially inwardly oriented limb of the L forms an annular flange. In the region of its outer lateral surface, the longitudinally oriented limb has knurling, which extends over the entire circumference of the sleeve, has a specific axial length and is produced by means of a thread rolling machine in such a way that the tip or head diameter of the knurling is larger than the outside diameter of the sleeve and the core or base diameter of the knurling is smaller than the outside diameter of the sleeve. As the sleeve is installed in a bearing bore in the housing, the sleeve is pressed into the bearing bore with its annular flange first. When the knurled portion of the sleeve is inserted into the bearing bore, the tips or heads of the knurling are pressed into the inner wall of the bearing bore, the material of the inner wall of the bearing bore being squeezed or pressed into the spaces between the teeth of the knurling such that the inner wall adopts the contour of the knurling. This ensures that the sleeve is positionally secured even in the case of high rotational speeds of the rolling bearing and a high ambient temperature. Instead of the knurling of the sleeve, it is also possible to use a toothed formation, which should likewise be produced by means of a thread rolling machine.

DE 26 11 218 A1 discloses a positively locking and frictionally locking connection of a bearing shell of a rolling bearing to a housing wall or shaft. In this case, the bearing shell has a peripheral groove. The material of the housing wall or of the shaft, which is softer than the material of the bearing shell, is deformed by means of a press ram in such a way that material enters into the groove of the bearing shell in the radial direction. In order to reduce the compressive forces to be applied by means of the press ram, it is also proposed to press the material only in portions into the groove of the bearing shell through discrete contact points distributed in the circumferential direction between the press ram and the housing wall or shaft.

Finally, DE 101 53 432 C1 discloses a rolling bearing which is in the form of a ball bearing and the outer ring of which has a radially oriented flange. This flange has a wedge-shaped extension which revolves in the circumferential direction and forms a ram element. If, during the mounting of the rolling bearing with a housing wall, the rolling bearing is inserted into a bore in the housing wall until the flange is pressed against the housing wall, the ram element plastically deforms material of the housing wall radially inward, the plastically deformed material being accommodated in a positively locking manner in a circumferential depression in the bearing shell. An additional connection between the bearing shell and the housing wall is produced by providing the lateral surface of the bearing shell, which is supported in the bore in the housing wall, with knurling, remote from the flange (but directly adjacent to the depression), and this knurling is formed into the housing wall such that the positive lock which is produced rules out turning of the bearing shell in relation to the housing wall after mounting.

### OBJECT OF THE INVENTION

It is an object of the invention to propose a bearing unit which, taking the production and mounting expenditure into account, ensures good positional securing of a bearing shell with respect to an adjacent component.

### SUMMARY OF THE INVENTION

According to the invention, this object is achieved by the features of independent claim 1. Further refinements of the invention are defined by the features of dependent claims 2 to 7.

A bearing shell is used in a bearing unit according to the invention and, in the region of a bearing seat surface, is supported with respect to an adjacent component, for example in a receiving bore in a housing or a wall or a shaft or a journal. Here, the bearing seat surface may be cylindrical or slightly spherical in section along a bearing axis of the bearing unit. If the adjacent component is a shaft, the bearing seat surface is in the form of a radially inner lateral surface of the bearing shell, whereas the bearing seat surface is in the form of an outer lateral surface if the adjacent component is a housing. Even before the bearing shell and adjacent component are mounted, the bearing shell has at least one projection which extends radially beyond the bearing seat surface. Therefore, differently from documents DE 26 11 218 A1, DE 39 31 447 A1 and DE 101 53 432 C1, plastic deformation does not take place (exclusively) in order to form a projection during mounting; this makes mounting complicated and requires precise mounting control (in certain circumstances primarily by the customer). Instead, it is possible to produce the projections with both reduced expenditure and, under certain circumstances, with improved precision even before mounting. It goes without saying that, in addition to this feature according to the invention, it is also possible to obtain additional plastic deformation during mounting, as per the above-mentioned documents.

In principle, the present invention therefore initially follows the way of introducing a connection contour even before mounting which is known from DE 29 05 683 A1 and mentioned in the introduction.

However, the invention has recognized that the embodiment of a bearing unit known from DE 29 05 683 A1 requires a sleeve in addition to the bearing shells which are present anyway. Although the knurling of the sleeve, as proposed in DE 29 05 683 A1, can produce a good connection between the sleeve and housing, undesirable changes in position can occur between the bearing shell and sleeve during operation of the bearing unit. Deviating from this, the present invention proposes the introduction of a projection, which serves for connection to the adjacent component, directly into the bearing shell. This makes it possible not only to reduce the number of parts of the bearing unit, but also to simplify mounting by removing a mounting step and to eliminate an additional degree of freedom, which has a negative effect on the operation of the bearing unit, between the sleeve and bearing shell according to the prior art.

On the other hand, the present invention is based on the realization that a uniform, continuously circumferential distribution of projections in the form of a toothed formation or knurling as per DE 29 05 683 A1 entails significant disadvantages:
a) If a maximum mounting force is predefined, this is dependent on a desired elastic or plastic deformation owing to the toothed formation or knurling. The greater the number of teeth, the smaller the maximum mounting force and deformation which acts on a tooth. This means that the production accuracy for the teeth also rises as the number of teeth which act increases. In other words, this means that the embodiment known from DE 29 05 683 A1 requires large mounting forces in the case of a defined, desired production accuracy.
b) On the other hand, the knurling or the teeth interact continuously or virtually continuously with the adjacent component in the circumferential direction, in which case no “deformation routes” can be provided between adjacent teeth; instead, the materials are subjected to the same amount of loading in the circumferential direction.

The invention takes the above-mentioned findings into account in that one or more projections are provided merely in one partial circumferential region of the bearing shell, whereas a further partial circumferential region is formed without a projection. This makes it possible to reduce the total number of acting projections; in the extreme case, this can mean that merely one partial circumferential region, two partial circumferential regions, three partial circumferential regions are provided with at least one projection. This makes it possible to keep the mounting and joining forces required to a minimum without increased demands on the production accuracies and the dimensions of the projections, and also the fits between the bearing shell and adjacent component. On the other hand, the partial circumferential regions without a projection can be used deliberately as deformation regions. In an extreme case of the refinement of the bearing unit according to the invention, provision is made only of one projection or only of two, three or four projections, and these can be distributed uniformly or non-uniformly in the circumferential direction.

A possible further advantage of the refinement according to the invention may be that the bearing shell and adjacent component can be mounted merely in one, two, three or four or more selected angular positions, as a result of which it is possible to prevent erroneous mounting, as long as the angular orientation of the bearing shell in relation to the adjacent component is significant.

There are many different ways to configure the connection between the projection and adjacent component. By way of example, the projection can be subjected to elastic loading during mounting such that said projection, owing to the elastic prestress, is pressed against a lateral surface of the adjacent component, which is formed without a corresponding recess, so as to produce a frictional lock between the projection and adjacent component. It is likewise conceivable for the lateral surface of the adjacent component to have a recess into which the projection of the bearing shell “latches” during mounting. According to one particular proposal of the invention, the at least one projection is elastically deformable during the mounting of the bearing shell and adjacent component. In this case, the connection of the at least one projection to further parts of the bearing shell is selected in such a way that the radially acting contact stress generated during mounting in a contact surface between the projection and the component is sufficiently large to plastically deform the adjacent component in the region of the contact surface. In this case, a structural specification of the acting contact stress can be made, in particular, by way of
the material and the stiffness of the bearing shell,
the dimensions of the connection of the projection to further constituent parts of the bearing shell,
the selected fits between the bearing shell and adjacent component, and
the extent to which the projection extends beyond the bearing seat surface.

This refinement of the invention makes use, in particular, of the fact that a hardened material is selected anyway for the bearing shell owing to the provision of a rolling surface for the rolling bodies, whereas a relatively softer material is selected for the adjacent component. It is therefore possible for the projection to be formed plastically into the adjacent component during mounting or after mounting, such that a positively locking connection is produced, without increased outlay on production, between the recess formed into the adjacent component and the projection.
Here, on the one hand, the positively locking connection produced in this way can act axially, i.e. in the direction of the bearing axis. If the projection forms a type of “groove” in the adjacent component during mounting in the axial direction, a positive lock can be present in the axial direction, and this is greater in the joining direction than in the opposite direction, i.e. in the direction of the groove. However, accommodation of the projection in the plastically formed-in recess in a manner free from play on both sides in the axial direction is also possible.
On the other hand, the projection is also accommodated in the formed-in recess in a positively locking manner in the circumferential direction.

The plastic forming into the adjacent component can be assisted by heating the adjacent component before or during mounting. It is likewise conceivable that, at mounting temperature, the projection merely bears against the lateral surface of the adjacent component in a frictionally locking manner, while the recess associated with the projection is only formed in for operation of the bearing unit where an increased operating temperature is established.

According to a further proposal of the invention, the at least one projection is arranged upstream or downstream of a rolling surface provided by the bearing shell in the axial direction, i.e. in the direction of the bearing axis. Increased demands are usually placed on such a rolling surface with respect to roundness, dimensional stability and surfaces, and these demands can only be met with more difficulty if the projection of the bearing shell has to be produced or arranged in the region of the rolling surface. The invention remedies this by arranging the projection outside the rolling bearing surface, where lack of roundness, dimensional tolerances or surface impairments caused by the projection are more reasonable or do not occur.

It is particularly simple to produce the bearing shell for the bearing unit according to the invention if said bearing shell is a shaped part, for example made of an annular or strip-shaped semifinished product. In the shaping process, the bearing shell is produced, to a first approximation, with a U-shaped half longitudinal section. After the shaping, the bearing shell has a base limb which is oriented parallel to a bearing axis and forms the rolling surface. Furthermore, two side limbs are angled away from the base limb so as to be oriented transversely with respect to the bearing axis. Here, it may be advantageous if the at least one projection is arranged in a transition region from the base limb to the side limbs, i.e. as far as possible on the outer edge of the base limb, such that the main function of the bearing shell, that of providing the rolling surface, may be impaired to the smallest possible degree.

A further possible advantage of producing the projection in the transition region between a side limb and a base limb of the U is that shaping has already taken place in this transition region and increased the strength of the material. The additional shaping for producing the projection can further increase the degree of shaping with a resultant further increased strength.

A multifunctionality of the bearing shell is provided if at least one sealing ring, rolling body and/or a bearing cage is/are trapped between the above-mentioned side limbs such that these are fixed in the axial direction, if appropriate with a certain amount of play.

Investigations carried out by the applicant have shown that the above-mentioned desired effect of forming a recess into the adjacent component by the projection with readily manageable mounting forces is possible if the bearing shell is produced from steel, which can be hardened, whereas the adjacent component is produced from aluminum.

According to a further proposal of the invention, the bearing unit according to the invention is used for a starter of a motor vehicle. In this case, the adjacent component may be a housing of the starter, while a rotating starter shaft of the starter is mounted radially on the inside of the bearing unit.

Advantageous developments of the invention are evident from the claims, the description and the drawings. The advantages of features and of combinations of a plurality of features mentioned in the introductory part of the description are merely exemplary, and these do not necessarily have to be achieved by embodiments according to the invention. Further features can be gathered from the drawings - in particular the illustrated geometries and the dimensions of a plurality of components relative to each other and also the relative arrangement and operative connection thereof. The combination of features of different embodiments of the invention or of features of different claims is likewise possible, deviating from the selected dependencies of the claims, and is hereby suggested. This also applies to those features which are shown in separate drawings or are mentioned in the description thereof. These features can also be combined with features of different claims. Likewise, features mentioned in the claims can be omitted for further embodiments of the invention.

### BRIEF DESCRIPTION OF THE DRAWINGS

Further features of the invention emerge from the following description and the associated drawings, which schematically show exemplary embodiments of the invention and in which:

FIG. 1 shows a longitudinal section of a bearing unit according to the invention without an adjacent component;

FIG. 2 shows a detail II-II of the bearing unit according to the invention as shown in FIGS. 1; and

FIG. 3 shows a simplified illustration of a bearing shell for a bearing unit according to the invention, in a three-dimensional illustration.

### DETAILED DESCRIPTION OF THE INVENTION

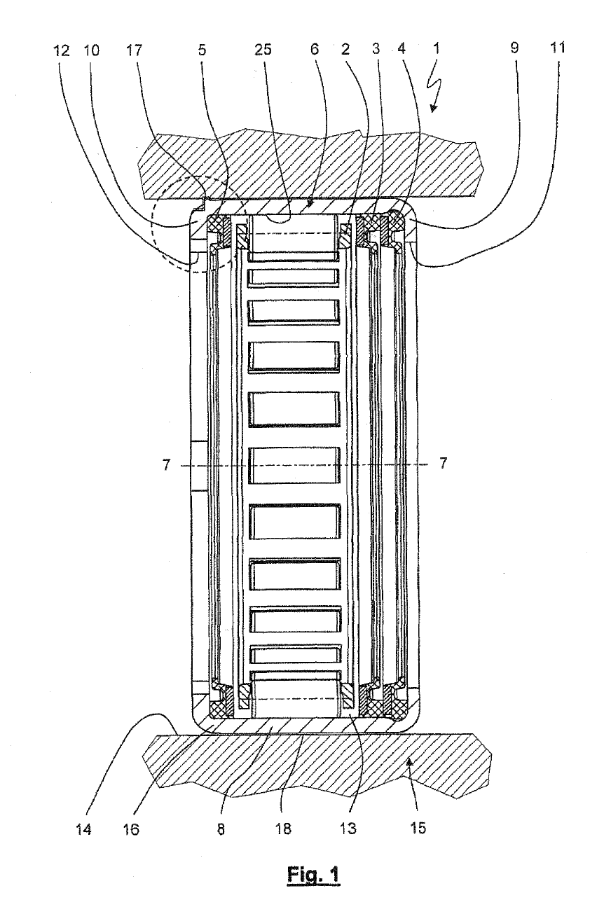

FIG. 1 shows a bearing unit 1 which is formed with a bearing cage 2, seals 3, 4, 5 arranged here on both sides of the bearing cage 2, and a bearing shell 6. The bearing shell 6 is U-shaped in a half longitudinal section with respect to the longitudinal axis or bearing axis 7-7, with a base limb 8 oriented parallel to the bearing axis 7-7 and two side limbs 9, 10 of approximately equal length which extend radially inward from the base limb 8. Owing to the shaping of the side limbs 9, 10, whereby the latter are unwound from a semifinished product, the transition regions between the base limb 8 and side limbs 9, 10 have a rounded design. End faces 11, 12 of the side limbs 9, 10 form bore for the passage of a shaft (not shown in the figures). Together with the bearing shell 6, this shaft forms a hollow-cylindrical circumferential inner space 13 of the bearing unit 1 with radial gaps between the end faces 11, 12 and the shaft, the inner space 13 being sealed by means of the seals 3, 4, 5. The seals 3, 4, 5, rolling bodies and the bearing cage 2 are arranged and enclosed in the inner space 13. The bearing shell 6 is inserted in a bore 14 in an adjacent component 15, in this case a housing or a supporting wall.

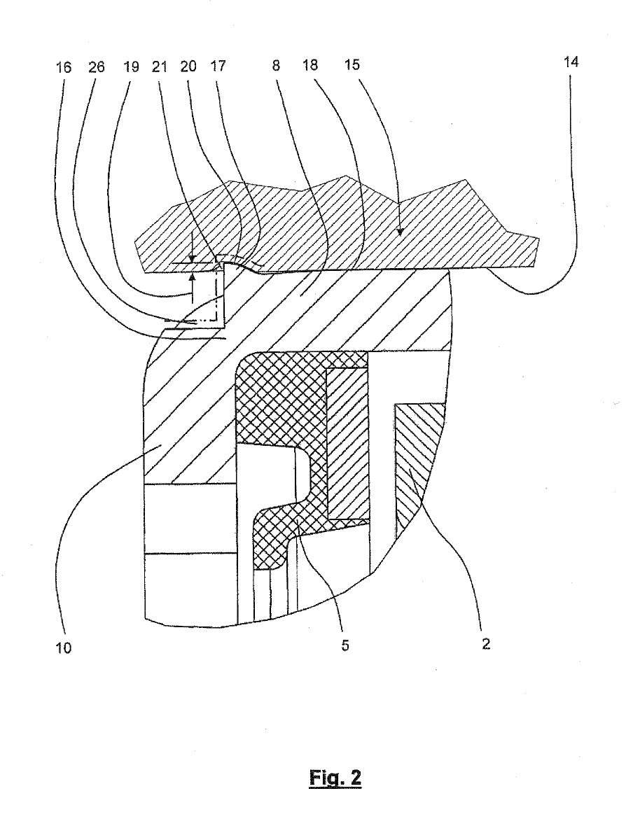

As can be seen from the detail in FIG. 2, the bearing shell 6 is equipped with a projection 17 in a transition region 16 between the side limb 10 and base limb 8. Whereas, for the exemplary embodiment shown, the base limb 8 forms a cylindrical bearing seat surface 18 radially on the outside, which is preferably accommodated in the bore 14 in the adjacent component 15 with a clearance fit, transition fit or press fit, the projection 17 extends beyond the diameter of the bearing seat surface 18 in the radial direction, for example by 50, 80, 100, 150, 200, 500 μm, deviations by ±20% from the above-mentioned dimensions also being possible. The extent to which the projection 17 extends beyond the bearing seat surface 18 radially outward is denoted in FIG. 2 by the insertion depth 19.

When the bearing shell 6 is inserted into the bore 14 in the adjacent component 15, the projection 17 presses against the bore 14 in the region of a contact surface 20. The contact stress acting in the contact surface 20 plastically deforms the adjacent component 15 in this region, and this produces a recess 26 in which the projection 17 can be accommodated in a positively locking manner both in the circumferential direction in relation to the bearing axis 7-7 and in the axial direction.

In the case of the exemplary embodiment shown in FIG. 2, the projection 17 is produced by cold forming or thermoforming of the transition region 16. For this purpose, a shaping tool is pressed against the transition region 16 in the direction of the bearing axis 7 in a partial circumferential region of said transition region, until the tool penetrates into the transition region 16 and produces a recess 26. The material which is displaced in order to produce the recess 26 is “pushed forward” (in simplified terms, comparable with pushing a shovel in snow) in front of the shaping tool and forms a thickened portion, which forms the projection 17, in front of the shaping tool. Therefore, in the embodiment shown, the recess 26 is formed upstream of the projection 17 in the axial direction outward. The contour of both the projection 17 and the recess 26 can be arbitrary in the half longitudinal section shown in FIG. 2. By way of example, in the half longitudinal section shown, the recess 26 is delimited in an L-shape, while the projection 17 resembles a tooth with a tooth flank oriented transversely with respect to the bearing axis, whereas the other tooth flank, in the transition region from the above-mentioned tooth flank, is oriented approximately parallel to the bearing axis 7-7 and then merges in a curved manner into the bearing seat surface 18.

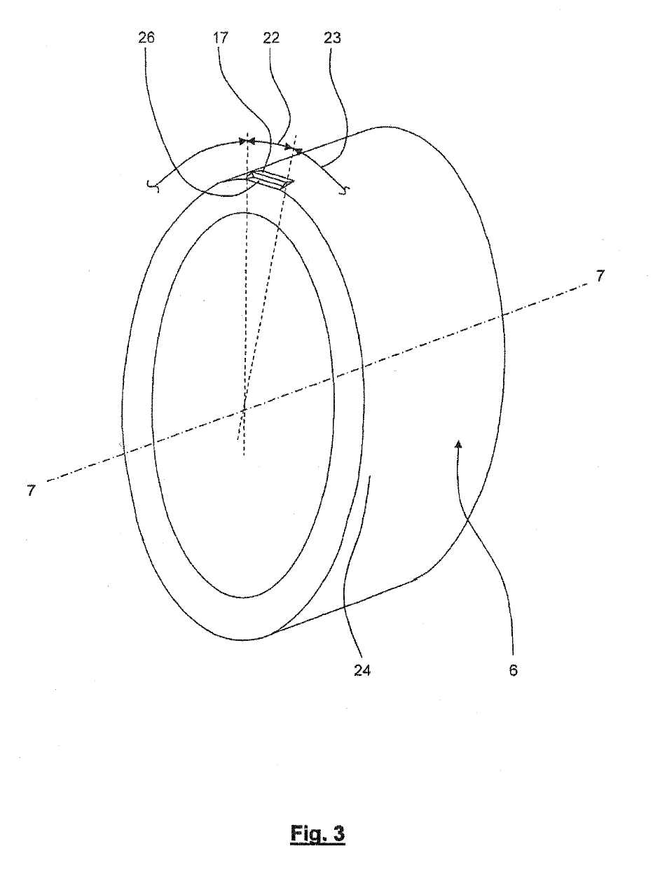

In the case of the exemplary embodiment shown in FIG. 3, the bearing shell 6 has merely one projection 17 which extends over a partial circumferential region 22, while the remaining, other partial circumferential region 23 has a substantially partly cylindrical form. The partial circumferential region 22, in which the projection 17 can be formed with a constant or varying insertion depth 19, can be at a circumferential angle of 1, 2, 4, 5, 8, 10, 15 or 20°, deviations of ±20% from the above-mentioned values also being possible. For an alternative refinement, it is possible to provide two, three, four or five projections 17 with a corresponding partial circumferential extent into the associated partial circumferential regions 22, a corresponding number of downsized partial circumferential regions 23 without projections 17 then being arranged between adjacent projections of this type. Here, the projections 17 may be distributed uniformly or non-uniformly in the circumferential direction.

In the exemplary embodiment shown, the projections 17 are produced by shaping the bearing shell 6. It is also possible for these projections to already be produced in the bearing shell 6 when it is produced, or to be subsequently fastened to a base body of the bearing shell.

According to the invention, the pressing between the bearing shell 6 and adjacent component 15 can be kept small and a secure fit can nevertheless be guaranteed. Instead of the projection 17 shown, it is possible to provide any desired burrs, retaining lugs, beads or barbs on the bearing shell 6 without thereby departing from the scope of the invention which is predefined by the claims. The production of the positive lock between the projection 17 and adjacent component 15 has no effects on the envelope circle diameter, as can arise, for example, in the form of a constriction as a result of excessive pressing. By way of example, the shaping tool may be a type of chisel.

In the partial circumferential region 23, the bearing shell 6 has a substantially cylindrical lateral surface 24. The bearing shell forms a rolling surface 25 for rolling bodies radially on the inside.

### LIST OF REFERENCE NUMERALS

1 Bearing unit

2 Bearing cage

3 Seal

4 Seal

5 Seal

6 Bearing shell

7 Longitudinal axis

8 Base limb

9 Side limb

10 Side limb

11 End face

12 End face

13 Inner space

14 Bore

15 Adjacent component

16 Transition region

17 Projection

18 Bearing seat surface

19 Insertion depth

20 Contact surface

21 Recess

22 Partial circumferential region

23 Partial circumferential region

24 Lateral surface

25 Rolling surface

26 Recess

1. A bearing unit, comprising:
a bearing shell
which is supported with respect to an adjacent component in a region of a hearing seat surface and forms a rolling surface for rolling bodies,
wherein
the bearing shell has at least one projection which extends radially beyond the bearing seat surface, before the bearing shell and adjacent component are mounted, and
at least one partial circumferential region having a substantially partly cylindrical lateral surface without a projection adjoins a partial circumferential region with the at least one projection, in a cross-section of the bearing shell.

2. The bearing unit of claim 1, wherein the connection of the at least one projection to the partly cylindrical lateral surface of the bearing shell is selected in such a way that, during mounting of the bearing shell and the adjacent component, a radially acting contact stress can be generated in a contact surface between the projection and the adjacent component, and the contact stress is sufficiently large to plastically deform the adjacent component in a region of the contact surface.

3. The bearing unit of claim 1, wherein the at least one projection is arranged upstream or downstream of a rolling surface of the bearing shell in an axial direction.

4. The bearing unit of claim 3, wherein the bearing shell is a shaped part having a U-shaped half longitudinal section with a base limb, which is oriented parallel to a bearing axis and forms the rolling surface, and two side limbs which are oriented transversely with respect to the bearing axis, wherein the at least one projection is arranged in a transition region from the base limb to a side limb.

5. The bearing unit of claim 4, wherein at least one seal, rolling body and/or a bearing cage is/are trapped between the side limbs.

6. The bearing unit of claim 1, wherein the bearing shell is produced from hardened steel and the adjacent component is produced from aluminum.

7. The bearing unit of claim 1, wherein the adjacent component is a housing of a starter for a motor vehicle, and a rotating starter shaft of the starter is mounted radially on an inside of the bearing unit.
